(19) United States
(12) Patent Application Publication
(10) Pub. No.: US 2008/0198520 A1
(43) Pub. Date: Aug. 21, 2008

(54) ELECTROSTATIC DISCHARGE PROTECTION CIRCUIT WITH LOWERED DRIVING VOLTAGE

(76) Inventor: Suk YUN, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/031,334

(22) Filed: Feb. 14, 2008

(30) Foreign Application Priority Data
Feb. 15, 2007 (KR) 10-2007-0016264

(51) Int. Cl. H02H 9/00

(52) U.S. Cl. 361/56

(57) ABSTRACT

The electrostatic discharge protection circuit coupled to an input/output pad includes a trigger unit providing a trigger voltage and an inverse trigger voltage having an inverse phase with respect to the trigger voltage. The trigger voltage and the inverse trigger voltage is provided in response to static electricity transferred from at least one of a first voltage line and a second voltage line. An electrostatic discharge protection unit configures an electrostatic discharge path among the first line, the second line, and an input/output pad in response to the trigger voltage and the inverse trigger voltage. In the electrostatic discharge protection circuit, the driving voltage of the electrostatic discharge protection unit is lowered, allowing static electricity to be effectively discharged.

### CROSS-REFERENCE TO RELATED APPLICATIONS

The present application claims priority to Korean patent application number 10-2007-0016264 filed on Feb. 15, 2007, which is incorporated herein by reference in its entirety.

### BACKGROUND OF THE INVENTION

The present invention relates to an electrostatic discharge protection circuit, and more particularly to an electrostatic discharge protection circuit for protecting an internal circuit from static electricity.

MOS transistors are widely used in electrostatic discharge protection circuits. FIG. 1 shows a typical electrostatic discharge protection circuit having a structure wherein a PMOS transistor P1 is coupled between a power voltage line VDD and an input/output pad 10, and an NMOS transistor N1 is coupled between a ground voltage line VSS and the input/output pad 10.

In the electrostatic discharge protection circuit shown in FIG. 1, the gate of the NMOS transistor N1 is coupled to the ground voltage line VSS, and the gate of the PMOS transistor P1 is coupled to the power voltage line VDD. The electric potential between the gate and the source of each of the NMOS transistor N1 and the PMOS transistor P1 do not reach the threshold voltage during normal operation of a memory chip. This in turn keeps the NMOS transistor N1 and the PMOS transistor P1 from operating during the normal operation of the memory chip.

A high voltage is applied to the input/output pad 10 in the event of an electrostatic discharge, causing an avalanche breakdown in the drain portion of the NMOS transistor N1 or the source portion of the PMOS transistor P1.

The carrier then flows to the pick-up of the NMOS transistor N1 or the PMOS transistor P1 and raises the electric potential of the substrate, thereby inducing a diode operation between the substrate and the source or the substrate and the drain to allow the flow of current.

Accordingly, the electrostatic current from the input/output pad 10 flows through the NMOS transistor N1 or the PMOS transistor P1 to the ground voltage line VSS or the power voltage line VDD, thus protecting the internal circuit 14 from static electricity.

The development of semiconductor fabrication technology has lead to a gradual decrease in the thickness of the gate oxide layer of a MOS transistor, and accordingly the level of the gate oxide breakdown voltage has correspondingly lowered.

However, the conventional electrostatic discharge protection circuit shown in FIG. 1 has a high avalanche breakdown voltage (which is an operation voltage thereof) leading to a breakdown in the thin gate oxide layer, and thus the internal circuit 14 is not sufficiently protected from static electricity when the the gate oxide breakdown voltage is lower than the avalanche breakdown voltage at which the electrostatic discharge protection device operates.

FIG. 2 shows an electrostatic discharge protection circuit designed to solve the problem described above.

Referring to FIG. 2, when static electricity flows from the input/output pad 10; a PMOS transistor P2, an NMOS transistor N2, and an NMOS transistor N3 which is a power clamp device operate due to the voltage drop by resistors R1 and R2 and capacitors C1 and C2, thus allowing static electricity to be discharged to respective voltage lines VDD and VSS.

The conventional electrostatic discharge protection circuit shown in FIG. 2 operates as the trigger voltages of respective MOS transistors P2, N2, and N3 are lowered, thus providing effective protection to the internal circuit 14 from static electricity.

However, the resistors R1 and R2 and the capacitors C1 and C2 of the convention electrostatic discharge protection circuit occupy a large area, which results in an increased total area of the electrostatic discharge protection circuit.

### SUMMARY OF THE INVENTION

Accordingly, an object of the present invention is to provide an electrostatic discharge protection circuit in which the operation voltage of MOS transistors constituting an electrostatic discharge protection device is lowered to prevent defects in the MOS transistors of the electrostatic discharge protection circuit.

Another object of the present invention is to provide an electrostatic discharge protection circuit having a superior electrostatic discharge performance without occupying a large area.

To achieve these objects of the present invention, an embodiment of the present invention provides an electrostatic discharge protection circuit that comprises: a trigger unit providing a trigger voltage and an inverse trigger voltage having an inverse phase with respect to the trigger voltage, wherein the trigger voltage and the inverse trigger voltage are provided in response to static electricity transferred from at least one of a first voltage line and a second voltage line; and an electrostatic discharge protection unit which configures an electrostatic discharge path for discharging the static electricity among the first voltage line, the second voltage line, and an input/output pad in response to the trigger voltage and the inverse trigger voltage.

The trigger unit includes a voltage dropping unit which provides the trigger voltage by dropping an electric potential of the static electricity; and an inverting unit which inverts the phase of the trigger voltage and provides it as the inverse trigger voltage.

The voltage dropping unit includes a capacitor and a resistor which are serially coupled between the first voltage line and the second voltage line. The trigger voltage is generated in a node at the junction of the serially coupled capacitor and resistor.

The inverting unit includes an inverter which inverts the phase of the trigger voltage and outputs the inverted trigger voltage as the inverse trigger voltage.

The electrostatic discharge protection unit includes a first MOS transistor which configures a first electrostatic discharge path between the first voltage line and the input/output pad in response to the inverse trigger voltage; and a second MOS transistor which configures a second electrostatic discharge path between the second voltage line and the input/output pad in response to the trigger voltage.

The first MOS transistor is a PMOS transistor coupled between the input/output pad and the first voltage line, and the reverse trigger voltage is input to a gate of the PMOS transistor; and the second MOS transistor is an NMOS transistor coupled between the input/output pad and the second voltage line, and the trigger voltage is input to a gate of the NMOS transistor.

The electrostatic discharge protection unit configures the electrostatic discharge path among the first voltage line, the second voltage line, and the input/output pad by performing respective parasitic bipolar operations of the first and second MOS transistors according to the static electricity flowing from the input/output pad to the respective first and second MOS transistors.

The first voltage line is a power voltage line and the second voltage line is a ground voltage line

According to another embodiment of the present invention, an electrostatic discharge protection circuit comprises: a trigger unit which generates a trigger voltage corresponding to a potential drop by dropping an electric potential of the static electricity transferred from at least one of a first voltage line and a second voltage line, and which generates an inverse trigger voltage inverting a phase of the trigger voltage; a first driving unit receiving the inverse trigger voltage, wherein the first driving unit configures a first electrostatic discharge path between the first voltage line and an input/output pad in response to the received inverse trigger voltage; and a second driving unit receiving the trigger voltage, wherein the second driving unit configures a second electrostatic discharge path between the second voltage line and the input/output pad in response to the received trigger voltage.

The trigger unit includes a capacitor coupled between the first voltage line and a node, wherein the trigger voltage is output from the node; a resistor coupled between the second voltage line and the node from which the trigger voltage is outputted; and an inverter coupled to the node, wherein the inverter inverts the phase of the trigger voltage to output the inverse trigger voltage.

The first driving unit is a PMOS transistor coupled between the input/output pad and the first voltage line, and the reverse trigger voltage is input to the gate of the PMOS transistor; and the second driving unit is a NMOS transistor coupled between the input/output pad and the second voltage line and the reverse trigger voltage is input to a gate of the NMOS transistor.

The first driving unit configures the first electrostatic discharge path between the first voltage line and the input/output pad by performing a parasitic bipolar operation according to the static electricity flowing from the input/output pad to the first driving unit.

The second driving unit configures the second electrostatic discharge path between the input/output pad and the second voltage line by performing a parasitic bipolar operation according to the static electricity flowing from the input/output pad to the second driving unit.

The first voltage line is a power voltage line, and the second voltage line is a ground voltage line.

### BRIEF DESCRIPTION OF THE DRAWINGS

FIG. 1 is a circuit diagram illustrating an example of a conventional electrostatic discharge protection circuit.

FIG. 2 is a circuit diagram illustrating another example of a conventional electrostatic discharge protection circuit.

FIG. 3 is a circuit diagram showing an electrostatic discharge protection circuit according to an embodiment of the present invention.

FIG. 4 is a waveform diagram in which operation properties of the PMOS transistor P1 of FIG. 1 and the PMOS transistor P3 of FIG. 3 are snapback simulated.

### DESCRIPTION OF SPECIFIC EMBODIMENTS

Hereinafter, preferred embodiments of the present invention will be described in detail with reference to the accompanying drawings.

In the electrostatic discharge protection circuit of the present invention, a main electrostatic discharge protection device (e.g. a MOS transistor) is driven using a trigger circuit which provides a trigger voltage, which corresponds to a drop in the potential of static electricity, and an inverse trigger voltage, thereby lowering the operation voltage of the electrostatic discharge protection device.

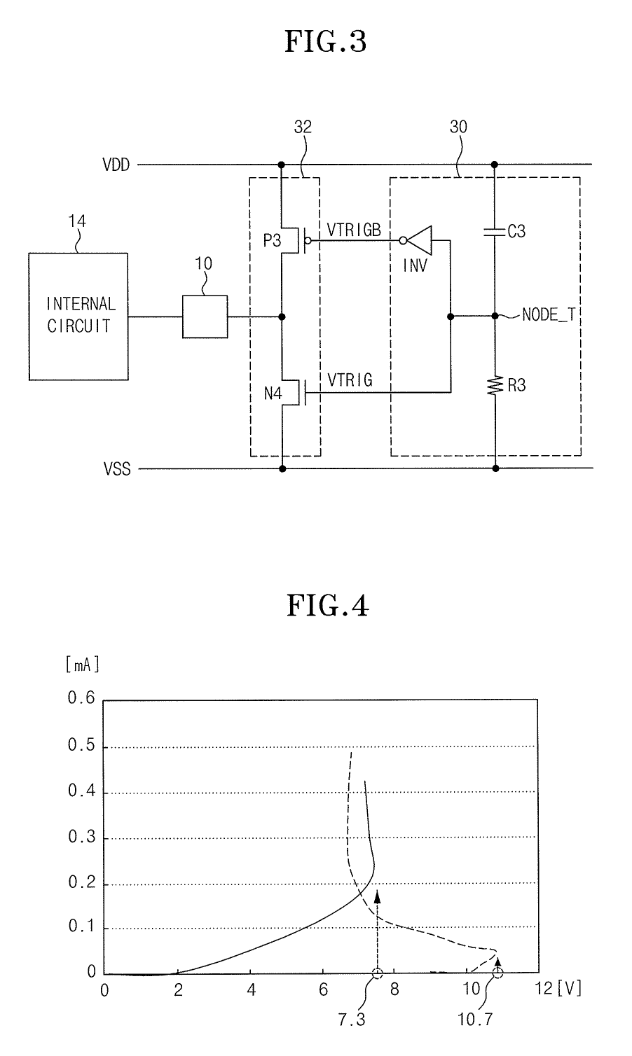

Referring to FIG. 3, the electrostatic discharge protection circuit of the present invention includes a trigger unit 30 and an electrostatic discharge protection unit 32.

The trigger unit 30 provides a trigger voltage VTRIG and an inverse trigger voltage VTRIGB (which has a phase that is inverse to the phase of the trigger voltage VTRIG) when static electricity is transferred from at least one of the power voltage line VDD and the ground voltage line VSS.

The trigger unit 30, which provides the trigger voltage VTRIG and the inverse trigger voltage VTRIGB, may include a voltage dropping unit and an inverting unit.

The voltage dropping unit provides a trigger voltage VTRIG corresponding to a potential drop by dropping the electric potential of the static electricity that is transferred from the power voltage line VDD and/or the ground voltage line VSS.

Herein, the voltage dropping unit may include a capacitor C3 coupled between the power voltage line VDD and a node NODE_T, and a resistor R3 coupled between the node NODE_T and the ground voltage line VSS, as is shown in FIG. 3.

The inverting unit inverts the phase of the trigger voltage VTRIG to provide the inverse trigger voltage VTRIGB.

Herein, the inverting unit may include an inverter INV which inverts the phase of the trigger voltage VTRIG to provide the inverse trigger voltage VTRIGB.

The electrostatic discharge protection unit 32 configures a first electrostatic discharge path between the power voltage line VDD and the input/output pad 10 in response to at least one of static electricity flowing from the input/output pad 10 and the inverse trigger voltage VTRIGB; and configures a second electrostatic discharge path between the ground voltage line VSS and the input/output pad 10 in response to at least one of static electricity flowing from the input/output pad 10 and/or the trigger voltage VTRIG.

The electrostatic discharge protection unit 32, which configures the electrostatic discharge paths among the power voltage line VDD, the ground voltage line VSS, and the input/output pad 10, may include a first driving unit and a second driving unit.

The first driving unit is driven by the inverse trigger voltage VTRIGB and configures the first electrostatic discharge path between the power voltage line VDD and the input/output pad 10.

Additionally, the first driving unit may provide the first electrostatic discharge path between the power voltage line VDD and the input/output pad 10 by performing a respective parasitic bipolar operation according to the static electricity flowing from the input/output pad.

As shown in FIG. 3, the first driving unit may include a PMOS transistor P3 coupled between the input/output pad 10 and the power voltage line VDD. The inverse trigger voltage VTRIGB is input to the gate of the PMOS transistor P3.

The second driving unit is driven by the trigger voltage VTRIG and configures a second electrostatic discharge path between the ground voltage line VSS and the input/output pad 10.

Additionally, the second driving unit may configure the second electrostatic discharge path between the ground voltage line VSS and the input/output pad 10 by performing a respective parasitic bipolar operation according to static electricity flowing from the input/output pad.

The second driving unit may include a NMOS transistor N4 coupled between the input/output pad 10 and the ground voltage line VSS. The trigger voltage VTRIG is input to the gate of the NMOS transistor N4.

Hereinafter, the operation of the electrostatic discharge protection circuit in accordance with an embodiment of the present invention will be described in detail. First, when the node NODE_T is at a ground voltage level, the PMOS transistor P3 and the NMOS transistor N4 are not operated by the high level inverse trigger voltage VTRIGB and the low level trigger voltage VTRIG.

When excessive electrostatic voltage caused by an electrostatic discharge flows in the input/output pad 10, current flows between the power voltage line VDD and the ground voltage line VSS raising the node NODE_T to a high voltage level. With the node NODE_T raised to a high voltage level, the trigger voltage VTRIG becomes a high voltage level and the inverse trigger voltage VTRIGB is inverted to a low voltage level. As such, the PMOS transistor P3 and the NMOS transistor N4 operate.

For example, when a positive static electricity flows in from the input/output pad 10, an electrostatic current passes through the PMOS transistor P3, the capacitor C3, and the resistor R3.

A voltage drop occurs as the electrostatic current passes through the capacitor C3 and the resistor R3, and the electric potential of the node NODE_T, i.e. the trigger voltage VTRIG, is raised to a high voltage level. The driving ability of the NMOS transistor N4 is enhanced by the high level trigger voltage VTRIG provided as described above, and accordingly an electrostatic discharge path is formed quicker and for a longer period of time between the input/output pad 10 and the ground voltage line VSS.

Additionally, the high level trigger voltage VTRIG is phase inverted using the inverter INV and is output as the low level inverse trigger voltage VTRIGB. The driving ability of the PMOS transistor P3 is enhanced by the low level inverse trigger voltage VTRIGB provided as described above, and accordingly an electrostatic discharge path is formed quicker and for a longer period time between the input/output pad 10 and the power voltage line VDD.

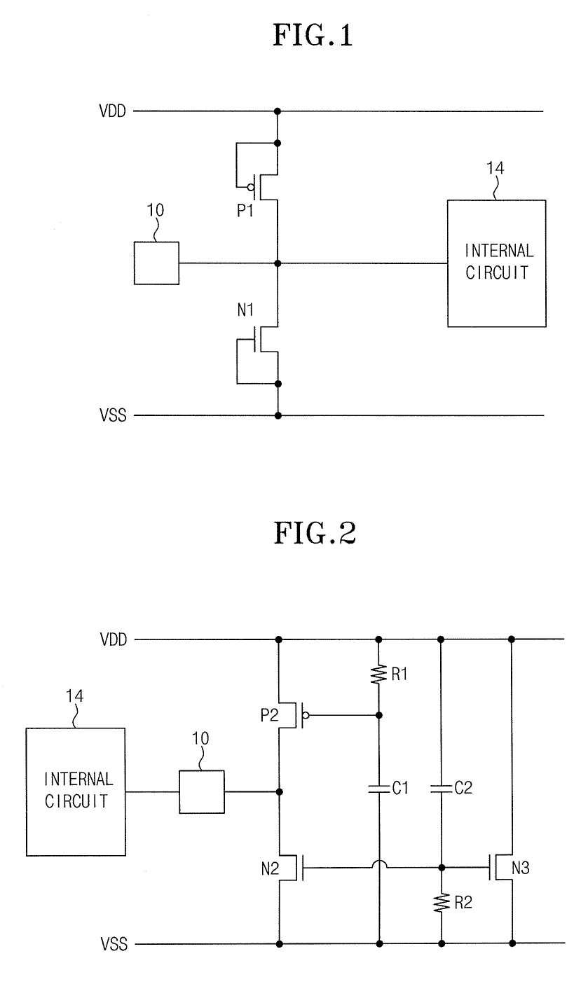

In FIG. 4, the properties of the PMOS transistor P1 of the conventional electrostatic discharge protection circuit shown in FIG. 1 are compared to the properties of the PMOS transistor P3 of the electrostatic discharge protection circuit of the present invention shown in FIG. 3. Referring to FIG. 4, the trigger voltage of the PMOS transistor P1 of the conventional electrostatic discharge protection circuit is about 10.7V as shown by the dotted line in FIG. 4, while the trigger voltage of the PMOS transistor P3 of the electrostatic discharge protection circuit of the present invention is about 7.4V as shown by the solid line in FIG. 4 and lowered by about 3.3V. It can be appreciated that the PMOS transistor P3 of the electrostatic discharge protection circuit of the present invention operates faster than the PMOS transistor P1 of the conventional electrostatic discharge protection circuit.

As described above, the electrostatic discharge protection circuit in accordance with the present invention supplies the trigger voltage VTRIG generated by the voltage drop of the static electricity and the inverse trigger voltage VTRIGB having a phase that is inverse with respect to a phase of the trigger voltage to the NMOS transistor N4 and the PMOS transistor P3 (which are the main electrostatic discharge protection devices) respectively.

Accordingly, the driving voltages of the PMOS transistor P3 and the NMOS transistor N4 are lowered allowing electrostatic discharge to be performed normally even with thin gate oxide layers.

Additionally, the electrostatic discharge protection circuit in accordance with the present invention uses a CMOS logic circuit, such as the inverter INV, to generate the inverse trigger voltage VTRIGB for enhancing the driving ability of the PMOS transistor P3. The present invention, which uses the CMOS logic circuit, occupies less area than the conventional electrostatic discharge protection circuit, which uses the capacitors C1 and C2 and the resistors R1 and R2 as shown in FIG. 2.

As is apparent from the above description, the present invention supplies the above described trigger voltage and inverse trigger voltage to the gates of the NMOS transistor and the PMOS transistor (the main electrostatic discharge protection devices). As such, the driving voltage of the electrostatic discharge protection devices is lowered. Accordingly, it is possible to prevent defects in the MOS transistors allowing effective electrostatic discharge to be performed.

Additionally, in the present invention, the driving voltage of the PMOS transistor (a main electrostatic discharge protection device) is lowered using a CMOS logic circuit such as the inverter, making it possible to discharge static electricity without occupying a large area.

Those skilled in the art will appreciate that the specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

What is claimed is:

1. An electrostatic discharge protection circuit coupled to an input/output pad, comprising:
a trigger unit providing a trigger voltage and an inverse trigger voltage, the inverse trigger voltage having an inverse phase with respect to the trigger voltage, wherein the trigger voltage and the inverse trigger voltage are provided in response to static electricity transferred from at least one of a first voltage line and a second voltage line; and
an electrostatic discharge protection unit which configures an electrostatic discharge path for discharging the static electricity, the electrostatic discharge path being configured among the first voltage line, the second voltage line, and the input/output pad in response to the trigger voltage and the inverse trigger voltage.

2. The electrostatic discharge protection circuit as set forth in claim 1, wherein, the trigger unit includes:
a voltage dropping unit which provides the trigger voltage by dropping an electric potential of the static electricity; and
an inverting unit which inverts the phase of the trigger voltage and provides the inverted trigger voltage as the inverse trigger voltage.

3. The electrostatic discharge protection circuit as set forth in claim 2, wherein:
the voltage dropping unit comprises a capacitor and a resistor which are serially coupled between the first voltage line and the second voltage line, and
the trigger voltage is generated at a node between the capacitor and the resistor.

4. The electrostatic discharge protection circuit as set forth in claim 2, wherein the inverting unit includes an inverter which inverts the phase of the trigger voltage and outputs the inverse trigger voltage.

5. The electrostatic discharge protection circuit as set forth in claim 1, wherein the electrostatic discharge protection unit includes:
a first MOS transistor which configures a first electrostatic discharge path between the first voltage line and the input/output pad in response to the inverse trigger voltage; and
a second MOS transistor which configures a second electrostatic discharge path between the second voltage line and the input/output pad in response to the trigger voltage.

6. The electrostatic discharge protection circuit as set forth in claim 5, wherein:
the first MOS transistor is a PMOS transistor coupled between the input/output pad and the first voltage line, and the inverse trigger voltage is input to a gate of the PMOS transistor, and
the second MOS transistor is an NMOS transistor coupled between the input/output pad and the second voltage line, and the trigger voltage is input to a gate of the NMOS transistor.

7. The electrostatic discharge protection circuit as set forth in claim 1, wherein the electrostatic discharge protection unit configures the electrostatic discharge path among the first voltage line, the second voltage line, and the input/output pad by performing a parasitic bipolar operation when the static electricity flows from the input/output pad to the electrostatic discharge protection unit.

8. The electrostatic discharge protection circuit as set forth in claim 1, wherein the first voltage line is a power voltage line and the second voltage line is a ground voltage line.

9. An electrostatic discharge protection circuit coupled to an input/output pad, comprising:
a trigger unit generating a trigger voltage by dropping an electric potential of static electricity transferred from at least one of a first voltage line and a second voltage line and generating an inverse trigger voltage by inverting a phase of the trigger voltage;
a first driving unit receiving the inverse trigger voltage, wherein the first driving unit configures a first electrostatic discharge path between the first voltage line and the input/output pad in response to the received inverse trigger voltage; and
a second driving unit receiving the trigger voltage, wherein the second driving unit configures a second electrostatic discharge path between the second voltage line and the input/output pad in response to the received trigger voltage.

10. The electrostatic discharge protection circuit as set forth in claim 9, wherein the trigger unit includes:
a capacitor coupled between the first voltage line and a node, wherein the trigger voltage is output from the node;
a resistor coupled between the second voltage line and the node from which the trigger voltage is outputted; and
an inverter coupled to the node, wherein the inverter inverts the phase of the trigger voltage to output the inverse trigger voltage.

11. The electrostatic discharge protection circuit as set forth in claim 9, wherein:
the first driving unit comprises a PMOS transistor coupled between the first voltage line and the input/output pad, and the inverse trigger voltage is input to a gate of the PMOS transistor, and
the second driving unit comprises a NMOS transistor coupled between the input/output pad and the second voltage line and the trigger voltage is input to a gate of the NMOS transistor.

12. The electrostatic discharge protection circuit as set forth in claim 9, wherein the first driving unit configures the first electrostatic discharge path between the first voltage line and the input/output pad by performing a parasitic bipolar operation according to the static electricity flowing from the input/output pad to the first driving unit.

13. The electrostatic discharge protection circuit as set forth in claim 9, wherein the second driving unit configures the second electrostatic discharge path between the second voltage line and the input/output pad by performing a parasitic bipolar operation according to the static electricity flowing from the input/output pad to the second driving unit.

14. The electrostatic discharge protection circuit as set forth in claim 9, wherein the first voltage line is a power voltage line and the second voltage line is a ground voltage line.
